(19) United States
(12) Patent Application Publication
(10) Pub. No.: US 2009/0196654 A1
(43) Pub. Date: Aug. 6, 2009

(54) ELECTROPHOTOGRAPHIC PHOTORECEPTOR CONTAINING MIXTURE OF BISPHTHALOCYANINE-BASED COMPOUND AND PHTHALOCYANINE-BASED COMPOUND AND ELECTROPHOTOGRAPHIC IMAGING APPARATUS EMPLOYING THE ELECTROPHOTOGRAPHIC PHOTORECEPTOR

(75) Inventor: An-kee LIM, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/275,579

(22) Filed: Nov. 21, 2008

(30) Foreign Application Priority Data
Jan. 31, 2008 (KR) 2008-10364

(51) Int. Cl. G03G 15/00; G03G 5/06

(52) U.S. Cl. 399/159; 430/78; 430/57.1

(57) ABSTRACT

An electrophotographic photoreceptor includes an electrically conductive substrate, and a photosensitive layer formed on the electrically conductive substrate, in which the photosensitive layer includes a mixture of a bisphthalocyanine compound represented by a formula and a phthalocyanine compound represented by another formula. The mixture of the bisphthalocyanine compound represented by the formula and the phthalocyanine compound represented by the other formula has higher stability with respect to a transition of crystal type, crystal growth, and/or agglomeration in a photosensitive layer forming composition than a phthalocyanine-based charge generating material. Therefore, the electrophotographic photoreceptor including the mixture as a charge generating material has excellent and stable electrical properties. In addition, the electrophotographic photoreceptor can be prepared with relatively low manufacturing costs.

### CROSS-REFERENCE TO RELATED APPLICATIONS

This application claims priority under 35 U.S.C. §119(a) from Korean Patent Application No. 10-2008-0010364, filed on Jan. 31, 2008, in the Korean Intellectual Property Office, the disclosure of which is incorporated herein in its entirety by reference.

### BACKGROUND OF THE INVENTION

1. Field of the Invention

The present general inventive concept relates to an electrophotographic photoreceptor and an electrophotographic imaging apparatus including the same, and more particularly, to an electrophotographic photoreceptor including a charge generating material including a mixture of a bisphthalocyanine-based compound and a phthalocyanine-based compound to obtain excellent and stable electrical properties, and an electrophotographic imaging apparatus including the same.

2. Description of the Related Art

Electrophotographic photoreceptors are used in electrophotography in laser printers, photocopiers, CRT printers, facsimile machines, LED printers, liquid crystal display printers, large platters, and laser electrophotographs. An electrophotographic photoreceptor includes a photosensitive layer on an electrically conductive substrate, and can be in the form of a plate, disc, sheet, belt, drum, or the like. In electrophotography, images are formed using an electrophotographic photoreceptor according to the following process. First, a surface of the photosensitive layer is uniformly and electrostatically charged, and then the charged surface is exposed to a pattern of light, thus forming the image. The light exposure selectively dissipates the charge in the exposed regions where the light strikes the surface, thereby forming a pattern of charged and uncharged regions, which is referred to as a latent image. Then, a wet or dry toner is provided in a vicinity of the latent image, and toner droplets or particles collect in either the charged or uncharged regions to form a toner image on the surface of the photosensitive layer. The resulting toner image may be transferred to a suitable final or intermediate receiving surface, such as paper, or the photosensitive layer may function as the final receptor for receiving the image.

Electrophotographic photoreceptors are generally categorized into two types. The first is a laminated type electrophotographic photoreceptor having a laminated structure including a charge generating layer (CGL) including a binder resin and a charge generating material (CGM), and a charge transporting layer (CTL) including a binder resin and a charge transporting material (usually, a hole transporting material (HTM)). In general, laminated type electrophotographic photoreceptors constitute negative (−) type electrophotographic photoreceptors. The other type is a single-layered type electrophotographic photoreceptor in which a binder resin, a CGM, an HTM, and an electron transporting material (ETM) are included in a single layer. In general, single-layered type electrophotographic photoreceptors constitute positive (+) type electrophotographic photoreceptors.

Generally, a laminated type electrophotographic photoreceptor includes: a metallic substrate including a metal oxide or insulating polymer film at a surface thereof; and a charge generating layer and a charge transporting layer which are sequentially stacked on the metallic substrate. The charge generating layer generates electrical signals upon exposure to light. The charge transporting layer transports the electric signal generated in the charge generating layer to a surface of the photoreceptor.

The CGM can be a photosensitive organic pigment or a photosensitive inorganic pigment. In general, however, a photosensitive organic pigment, such as an azo-based compound, a perylene-based compound, or a phthalocyanine-based compound, is used more than a photosensitive inorganic pigment, because a photosensitive organic pigment can have various crystal structures according to a synthesis method and processing conditions and thus electrical properties of the photoreceptor can be easily changed. Specifically, a phthalocyanine-based compound which is widely used as a blue pigment for ink and paint is suitable for a CGM of an electrophotographic photoreceptor due to its chemical and physical stability.

To use a phthalocyanine-based CGM to prepare an electrophotographic photoreceptor, the phthalocyanine-based CGM should be crushed into fine particles because, normally, the phthalocyanine-based CGM exists in a form of agglomerates. To do so, the phthalocyanine-based CGM is mixed with an appropriate organic solvent and a binder resin and the like and dispersed therein, thereby obtaining a coating dispersion including the organic solvent, the binder resin, and the phthalocyanine-based CGM. The coating dispersion is coated on an electrically conductive substrate and dried to form a photosensitive layer. However, when a particle size of the CGM is increased due to a transition of crystal type, crystal growth, or agglomeration in the coating dispersion, electrophotographic properties of the electrophotographic photoreceptor may be degraded, the photosensitive layer thereof may have locally non-uniform electrical properties, image defects, such as black spots or kaburi, occur, and/or the resolution of an image may be degraded. Therefore, the phthalocyanine-based CGM should have a long-term stability with respect to the transition of crystal type, crystal growth, or agglomeration in the coating dispersion.

It is known that a phthalocyanine-based compound has various crystal structures. These crystal structures are thermodynamically stable immediately after synthesis of the compound. However, when the crystal structure of the phthalocyanine-based compound is changed in a subsequent process following its synthesis for the purpose of electrophotographic use, the phthalocyanine-based compound becomes unstable or semi-stable. Specifically, a phthalocyanine-based compound is unstable with respect to the transition of crystal type, crystal growth, and/or agglomeration in an organic solvent.

All of the known phthalocyanine-based CGMs have at least one of the problems described above. For example, an oxotitanyl phthalocyanine having a Y-type crystal structure shows a strong diffraction peak at a Bragg's angle of 2θ=27.3° in an X-ray diffraction spectrum thereof. Such oxotitanyl phthalocyanine having Y-type crystal structure has a relatively good sensitivity but is unstable with respect to a solvent (refer to JP62-67094). Accordingly, a crystal characteristic of the CGM may be easily changed in a coating dispersion containing the CGM over time. That is, a coating dispersion containing the phthalocyanine-based CGM may have low storage stability, which may increase manufacturing costs of an electrophotographic photoreceptor. In addition, an electrophotographic photoreceptor including a photosensitive layer prepared using a coating dispersion containing a CGM in which the crystal structure has been changed has poor and unstable electrical properties and low reliability. Meanwhile, phthalocyanine-based compounds that are suppressed from the transition of crystal type, crystal growth, and/or agglomeration have been introduced to the ink and paint industries. Examples of such phthalocyanine-based compound include copper phthalocyanine having an aminomethyl group disclosed in JP 39-16787, JP 47-10831, and JP 50-21027; sulfonated copper phthalocyanine disclosed in U.S. Pat. No. 2,799,595; and copper phthalocyanine having a sulfonamide group disclosed in U.S. Pat. No. 2,861,005. However, an electrophotographic photoreceptor including a photosensitive layer prepared using a coating dispersion containing the phthalocyanine-based compound as a CGM may have poor electrical properties, such as low sensitivity and poor charged potential maintaining characteristics. Therefore, such phthalocyanine-based compounds are not suitable for the manufacture of an electrophotographic photoreceptor.

Therefore, there is a need to develop a phthalocyanine-based CGM that is stable with respect to the transition of crystal type, crystal growth, and/or agglomeration and an electrophotographic photoreceptor containing the phthalocyanine-based CGM.

Meanwhile, a large amount of mechanical friction occurs in an electrophotographic photoreceptor when incorporated in an electrophotographic imaging apparatus. Therefore, when an adhesive force between an electrically conductive substrate and a photosensitive layer is small, a photosensitive layer may easily exfoliated and thus durability of the electrophotographic photoreceptor may be degraded.

### SUMMARY OF THE INVENTION

The present general inventive concept provides an electrophotographic photoreceptor which uses a bisphthalocyanine compound-containing charge generating material (CGM) that has better stability with respect to the transition of crystal type, crystal growth, and/or agglomeration than a conventional phthalocyanine-based CGM to obtain excellent and stable electrical properties. In addition, the electrophotographic photoreceptor may be prepared with relatively low manufacturing costs. The present general inventive concept also provides an electrophotographic imaging apparatus including the electrophotographic photoreceptor.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an electrophotographic photoreceptor including an electrically conductive substrate, and a photosensitive layer formed on the electrically conductive substrate, wherein the photosensitive layer includes a mixture of a bisphthalocyanine compound represented by Formula 1 below and a phthalocyanine compound represented by Formula 2 below:

Pc1-X-Pc2 [Formula 1]

where Pc1 is represented by:

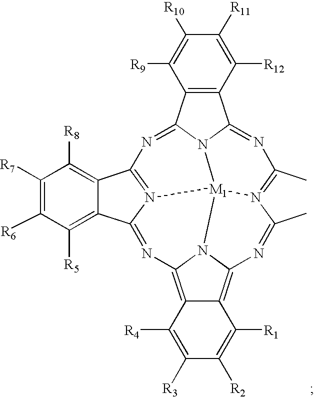

Pc2 is represented by:

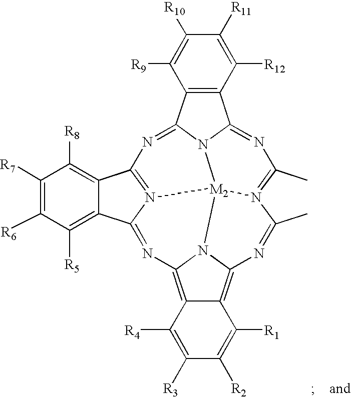

X is a quadrivalent connecting group represented by:

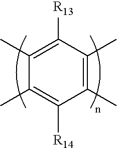

where R₁-R₁₄ are each independently a hydrogen atom, a halogen atom, a nitro group, an alkyl group, or an alkoxy group;

M₁ and M₂, which may be the same or different from each other, are each a hydrogen atom, Cu, Fe, Mg, Sn, Pb, Zn, Co, Ni, Mo, or halogenated aluminum, or Ti, V, Zr, Ge, Ga, Sn, Si or In with an oxygen atom, a halogen atom, or a hydroy group bonded thereto; and

n is an integer ranging from 1 to 3; and

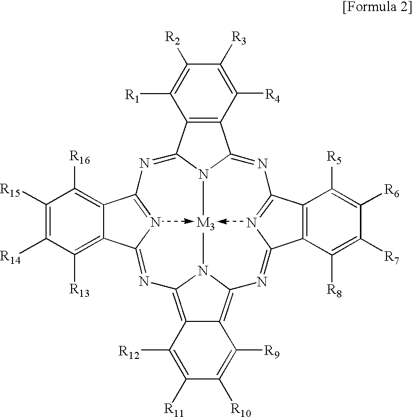

where M₃ is a hydrogen atom, Cu, Fe, Mg, Sn, Pb, Zn, Co, Ni, Mo, halogenated aluminum, or Ti, V, Zr, Ge, Ga, Sn, Si or In with an oxygen atom, a halogen atom, or a hydroxy group bonded thereto; and R1-R16 are each independently a hydrogen atom, a halogen atom, a nitro group, an alkyl group or an alkoxy group.

The photosensitive layer may be a single-layered type photosensitive layer having a charge generating capability and a charge transporting capability, or a laminated type photosensitive layer including a charge generating layer and a charge transporting layer.

The foregoing and/or other aspects and utilities of the general inventive concept may also be achieved by providing an electrophotographic imaging apparatus including the electrophotographic photoreceptor according to an aspect of the present general inventive concept.

The foregoing and/or other aspects and utilities of the general inventive concept may also be achieved by providing an electrophotographic photoreceptor including an electrically conductive substrate, and a photosensitive layer formed on the electrically conductive substrate, the photosensitive layer including a mixture of a bisphthalocyanine compound and a phthalocyanine compound.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrating an electrophotographic imaging apparatus according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

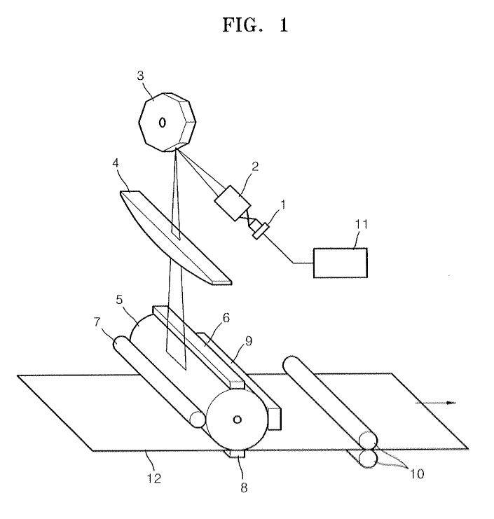

The present general inventive concept will now be described more fully with reference to FIG. 1, in which an exemplary embodiment of the general inventive concept is illustrated.

An electrophotographic photoreceptor according to an embodiment of the present general inventive concept includes an electrically conductive substrate; and a photosensitive layer formed on the electrically conductive substrate, wherein the photosensitive layer includes a mixture of a bisphthalocyanine compound represented by Formula 1 below and a phthalocyanine compound represented by Formula 2 below:

Pc1-X-Pc2 [Formula 1]

where Pc1 is represented by:

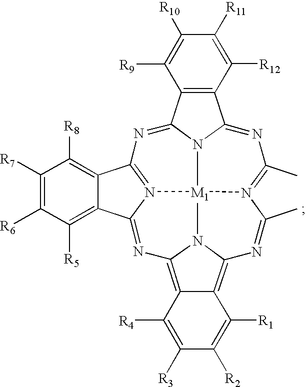

Pc2 is represented by:

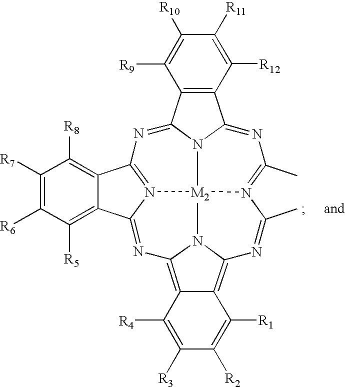

X is a quadrivalent connecting group represented by:

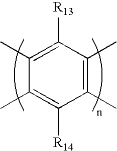

where R₁-R₁₄ are each independently a hydrogen atom, a halogen atom, a nitro group, an alkyl group, or an alkoxy group;

M₁ and M₂, which may be the same or different from each other, are each a hydrogen atom, Cu, Fe, Mg, Sn, Pb, Zn, Co, Ni, Mo, or halogenated aluminum, or Ti, V, Zr, Ge, Ga, Sn, Si or In with an oxygen atom, a halogen atom, or a hydroxy group bonded thereto; and

n is an integer ranging from 1 to 3; and

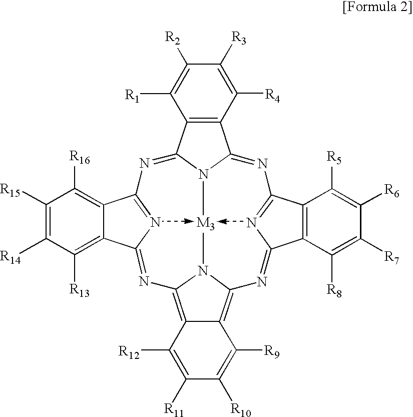

where M₃ is a hydrogen atom, Cu, Fe, Mg, Sn, Pb, Zn, Co, Ni, Mo, halogenated aluminum, or Ti, V, Zr, Ge, Ga, Sn, Si or In with an oxygen atom, a halogen atom, or a hydroxy group bonded thereto; and

R₁-R₁₆ are each independently a hydrogen atom, a halogen atom, a nitro group, an alkyl group, or an alkoxy group.

As described above, the electrophotographic photoreceptor according to the present embodiment includes the photosensitive layer formed on the electrically conductive substrate. The electrically conductive substrate may be in a form of a drum, pipe, belt, plate or the like which may include any conductive material, for example, a metal, or an electrically conductive polymer, or the like. The metal may be aluminium, vanadium, nickel, copper, zinc, palladium, indium, tin, platinum, stainless steel, chrome, or the like. The electrically conductive polymer may be a polyester resin, polycarbonate resin, a polyamide resin, a polyimide resin, mixtures thereof, or a copolymer of monomers used in preparing the resins described above in which an electrically conductive material such as a conductive carbon, tin oxide, indium oxide, or the like is dispersed. An organic polymer sheet on which a metal is deposited or a metal sheet is laminated may be used as the electrically conductive substrate.

In the electrophotographic photoreceptor according to the present embodiment, the photosensitive layer is formed on the electrically conductive substrate. The photosensitive layer includes a mixture of the bisphthalocyanine compound represented by Formula 1 and the phthalocyanine compound represented by Formula 2. That is, a charge generating material (CGM) included in the photosensitive layer used in the present embodiment is the mixture of the bisphthalocyanine compound represented by Formula 1 and the phthalocyanine compound represented by Formula 2:

Pc1-X-Pc2 [Formula 1]

where Pc1 is represented by:

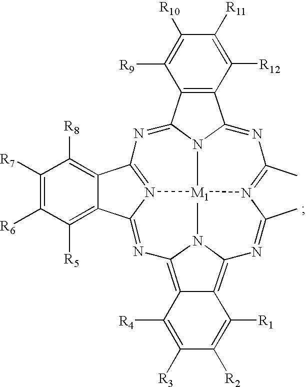

Pc2 is represented by:

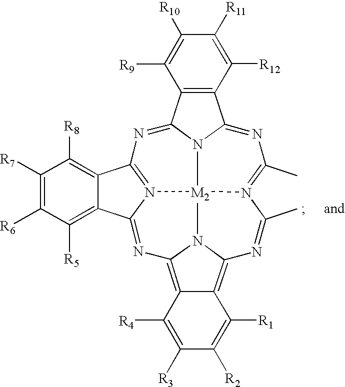

X is a quadrivalent connecting group represented by:

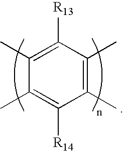

In formula 1, R₁-R₁₄ are each independently a hydrogen atom, a halogen atom, a nitro group, an alkyl group, or an alkoxy group; M₁ and M₂, which may be the same or different from each other, are each a hydrogen atom, Cu, Fe, Mg, Sn, Pb, Zn, Co, Ni, Mo, or halogenated aluminum, or Ti, V, Zr, Ge, Ga, Sn, Si or In with an oxygen atom, a halogen atom, or a hydroxy group bonded thereto. The alkyl group and the alkoxy group may have 1-30 carbons, such as 1-15 carbons, including 1-7 carbons. The alkyl group and the alkoxy group may be substituted with any substituent, such as a halogen atom, a nitro group and the like. The n is an integer ranging from 1 to 3, specifically from 1 to 2.

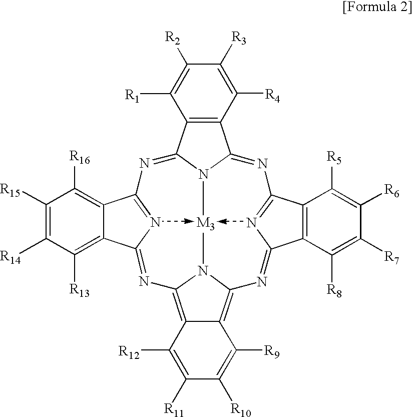

where M₃ is a hydrogen atom, Cu, Fe, Mg, Sn, Pb, Zn, Co, Ni, Mo, halogenated aluminum, or Ti, V, Zr, Ge, Ga, Sn, Si or In with an oxygen atom, a halogen atom, or a hydroxy group bonded thereto; and R₁-R₁₆ are each independently a hydrogen atom, a halogen atom, a nitro group, an alkyl group or an alkoxy group. The alkyl group and the alkoxy group may each have 1-30 carbon atoms, such as 1-15 carbon atoms, including 1-7 carbon atoms. The alkyl group and the alkoxy group may be substituted with any substituent, such as a halogen atom, a nitro group and the like.

The mixture of the bisphthalocyanine compound represented by Formula 1 and the phthalocyanine compound represented by Formula 2 may be, for example, a mixed crystal of the bisphthalocyanine compound represented by Formula 1 and the phthalocyanine compound represented by Formula 2. In the mixture, particularly in the mixed crystal, of the bisphthalocyanine compound represented by Formula 1 and the phthalocyanine compound represented by Formula 2, the bisphthalocyanine compound represented by Formula 1 may prevent a change in crystal characteristics of the phthalocyanine compound represented by Formula 2. That is, the bisphthalocyanine compound represented by Formula 1 increases stability of the phthalocyanine compound represented by Formula 2 with respect to the transition of crystal type, crystal growth, and/or agglomeration. Accordingly, the mixture, particularly, the mixed crystal has higher stability with respect to the transition of crystal type, crystal growth, and/or agglomeration in a coating dispersion to form a photosensitive layer than a conventional phthalocyanine-based CGM. Due to such high stability, a large amount of the coating dispersion including the mixture, particularly, the mixed crystal acting as a CGM can be prepared in advance and then used whenever a photoreceptor is manufactured, for a long period of time. As a result, an electrophotographic photoreceptor having excellent electrical properties can be prepared at low costs. That is, since there is no need to perform a time-consuming dispersing process, such as milling or grinding, to prepare a coating dispersion to form a photosensitive layer whenever a photoreceptor is manufactured, the process of preparing a photoreceptor can be simplified.

In the present embodiment, the mixed crystal refers to a crystal in which the bisphthalocyanine compound represented by Formula 1 and the phthalocyanine compound represented by Formula 2 are mixed each other in a molecular level in the primary particles thereof. The mixed crystal differs from a simple mixture of the bisphthalocyanine compound represented by Formula 1 and the phthalocyanine compound represented by Formula 2 and such difference can be easily identified using a known analysis method based on physical and/or chemical properties. For example, in the X-ray diffraction spectrum, infrared-ray absorption spectrum, or visible-ray absorption spectrum of the mixed crystal, there are new diffraction peaks or new absorption peaks which do not appear in the X-ray diffraction spectrum, infrared-ray absorption spectrum, or visible-ray absorption spectrum of each of the bisphthalocyanine compound represented by Formula 1 and the phthalocyanine compound represented by Formula 2. Therefore, the mixed crystal can be identified based on presence or absence of new peaks.

The mixed crystal of the bisphthalocyanine compound represented by Formula 1 and the phthalocyanine compound represented by Formula 2 shows good sensitivity over a wider wavelength range than a conventional phthalocyanine-based compound. Therefore, the mixed crystal can act as a phthalocyanine-based CGM suitable to perform digital signal processing.

The bisphthalocyanine compound represented by Formula 1 can be prepared using a tetracarbonitrile compound having a desired substituent, such as 1,2,4,5-benzentetracarbonitrile, using any known method (Eur. J. Org. Chem. 2003, 2080-2083). Such method can be understood with reference to the journal described above.

In the bisphthalocyanine compound represented by Formula 1, M1 that is a central metal of the Pc1 moiety and M2 that is a central metal of the Pc2 moiety may be the same or different from each other. The bisphthalocyanine compound may be the same type of bisphthalocyanine compound having the same substituents and central atoms of bisphthalocyanine compound, or may contain two or more types of bisphthalocyanine compounds having different substituents and/or central atoms.

The phthalocyanine compound represented by Formula 2 which is the other component to form the mixed crystal according to the present embodiment can be any compound that satisfies Formula 2. Examples of the phthalocyanine compound include a metal-free phthalocyanine, an oxotitanyl phthalocyanine, an oxovanadyl phthalocyanine, a copper phthalocyanine, an aluminum chloride phthalocyanine, a gallium chloride phthalocyanine, an indium chloride phthalocyanine, a germanium dichloride phthalocyanine, an aluminum hydroxide phthalocyanine, a gallium hydroxide phthalocyanine, an indium hydroxide phthalocyanine, a germanium dihydroxide phthalocyanine, and combinations thereof. Specifically, the phthalocyanine compound may be a metal-free phthalocyanine or an oxotitanyl phthalocyanine.

The phthalocyanine compound represented by Formula 2 used in the present embodiment can be easily synthesized using methods disclosed in F. H. Moser, A. L. Thomas, [symbol] Phthalocyanine Compounds [symbol] ; JP 1-142658; and JP 1-221461. The method of synthesizing the phthalocyanine compound represented by Formula 2 may be understood with reference to the prior art publications described above.

When the bisphthalocyanine compound represented by Formula 1 and the phthalocyanine compound represented by Formula 2 which are used to prepare the mixed crystal according to the present embodiment have the same central atoms, that is, when M1, M2, and M3 of Formulae 1 and 2 are the same each other, the bisphthalocyanine compound and the phthalocyanine compound may be simultaneously synthesized.

A weight ratio of the bisphthalocyanine compound represented by Formula 1 to the phthalocyanine compound represented by Formula 2 may be in a range of 0.01:1 to 1:1, specifically in a range of 0.05:1 to 0.1:1. When the weight ratio is less than 0.01:1, the phthalocyanine compound represented by Formula 2 may have an insufficient stability improvement effect with respect to the transition of crystal type, crystal growth, and/or agglomeration in the coating dispersion. Alternatively, when the weight ratio is greater than 1:1, a sensitivity of the mixed crystal may be degraded.

Hereinafter, a method of preparing a mixed crystal in an exemplary form of the mixture constituting a CGM in the present embodiment will be described in detail.

To obtain the mixed crystal according to the present embodiment, a bisphthalocyanine compound represented by Formula 1 and a phthalocyanine compound represented by Formula 2 should be mixed each other in a molecular level. The mixing can be performed using a chemical method, such as an acid pasting method or an acid slurry method, or a mechanical method. According to the chemical method, the bisphthalocyanine compound represented by Formula 1 and the phthalocyanine compound represented by Formula 2 are dissolved to a molecular level in a strong acid, such as sulfuric acid, and the obtained solution is poured into a solvent, such as water or an alcohol, to co-precipitate. According to the mechanical method, the bisphthalocyanine compound of Formula land the phthalocyanine compound of Formula 2 are physically mixed such that molecules of the compounds represented by Formulae 1 and 2 are fitted into in the same crystal lattice, using a grinding device or a milling device. In the mechanical method, the compounds represented by Formulae 1 and 2 should be completely ground and milled until amorphous forms are obtained. In this regard, homogeneous mixing of the compounds is very important for the bisphthalocyanine compound represented by Formula 1 to efficiently suppress the phthalocyanine compound represented by Formula 2 from the transition of crystal type, crystal growth, and/or agglomeration. When grinding or milling is performed, a predetermined content of an organic solvent and a binder resin can be present together with the compounds represented by Formulae 1 and 2.

The grinding device or milling device which is used to form the mixed crystal may be a ball mill, a sand-mill, a high-speed mixer, a roll-mill, a three-roll mill, a paint shaker, a vibration mill, or a kneader. When required, the grinding or milling can be performed using glass beads, steel beads, zirconium oxide beads, or alumina beads and the like.

In the obtained mixed crystal, the bisphthalocyanine compound represented by Formula 1 can effectively suppress a change in crystal characteristics of the phthalocyanine compound represented by Formula 2. That is, the bisphthalocyanine compound represented by Formula 1 improves stability of the phthalocyanine compound represented by Formula 2 with respect to the transition of crystal type, crystal growth, and/or agglomeration.

In the method of preparing an electrophotographic photoreceptor, the mixture of the compounds represented by Formulae 1 and 2, specifically the mixed crystal of the compounds represented by Formulae 1 and 2 may be further mixed with other known CGM, provided the effect of the present embodiment is obtained. The known CGM can be an organic material, such as an azo-based compound, a bisazo-based compound, a triazo-based compound, a quinone-based compound, a perylene-based compound, an indigo-based compound, a bisbenzoimidazole-based pigment, an anthraquinone-based compound, a quinacridone-based compound, an azulenium-based compound, a squarylium-based compound, a pyrilium-based compound, a triarylmethane-based compound, a cyanine-based compound, a perynone-based compound, a polycycloquinone-based compound, a pyrrolopyrrole-based compound and a naphthalocyanine-based compound; and inorganic materials such as amorphous silicon, amorphous selenium, rhombohedral selenium, tellurium, selenium-tellurium alloy, cadmium sulfide, antimony sulfide, and zinc sulfide. The respective materials can be used alone or in combinations.

The photosensitive layer formed on the electrically conductive substrate can be either a laminated type photosensitive layer in which a charge generating layer and a charge transporting layer are formed separately or a single-layered type photosensitive layer, that is, a charge generating and transporting layer that has a charge generating capability and a charge transporting capability.

With regard to the laminated type photosensitive layer, the mixture of the compounds represented by Formulae 1 and 2 having characteristics described above, specifically, the mixed crystal of the compounds represented by Formulae 1 and 2 is included in the charge generating layer. That is, when used in a laminated type photosensitive layer, the mixed crystal is dispersed together with a binder resin in a solvent to prepare a coating dispersion to form a charge generating layer and the obtained coating dispersion is coated on the electrically conductive substrate and dried, thereby forming a charge generating layer.

A thickness of the charge generating layer may be in a range of 0.001 to 10 μm, such as in a range of 0.05 to 2 μm, including in a range of 0.1 to 1 μm. When the thickness of the charge generating layer is less than 0.001 μm, obtaining a homogeneous charge generating layer is difficult. Alternatively, when the thickness of the charge generating layer is more than 10 μm, electrical properties may be degraded.

In general, a CGM including the mixture of the compounds represented by Formulae 1 and 2, specifically, the mixed crystal of the compounds represented by Formulae 1 and 2, does not have a film-forming capability. Therefore, a coating dispersion to form a charge generating layer including the mixture, specifically, the mixed crystal and a binder resin is prepared and then the obtained coating dispersion is coated on an electrically conductive substrate and dried to form a charge generating layer. Thus, the CGM in the charge generating layer is dispersed and/or dissolved within the binder resin.

Examples of the usable binder resins include polyvinyl butyral, polyvinyl acetal, polyester, polyamide, polyvinyl alcohol, polyvinyl acetate, polyvinyl chloride, polyurethane, polycarbonate, polymethacryl amide, polyvinyliden chloride, polystyrene, styrene-butadiene copolymer, styrene-methyl methacrylate copolymer, vinylidene chloride-acrylonitril copolymer, vinylchloride-vinyl acetate copolymer, vinylchloride-vinyl acetate-maleic anhydride copolymer, ethylene-acrylic acid copolymer, ethylene-vinyl acetate copolymer, methyl cellulose, ethyl cellulose, nitrocellulose, carboxymethyl cellulose, polysilicone, silicon-alkyd resin, phenol-formaldehyde resin, cresol-formaldehyde resin, phenoxy resin, styrene-alkyd resin, poly-N-vinycarbazole resin, polyvinylformal, polyhydroxystyrene, polynobonyl, polycycloolefin, polyvinylpyrrolidone, poly(2-ethyl-oxazoline), polysulfone, melamine resin, urea resin, amino resin, isocyanate resin, epoxy resin and the like. The respective binder resins may be used alone or in a combination of two or more of them.

In the charge generating layer, a content of the binder resin may be in a range of 5 to 350 parts by weight, specifically in a range of 10 to 200 parts by weight, based on 100 parts by weight of the CGM including the mixture of the compounds represented by Formulae 1 and 2, specifically, the mixed crystal of the compounds represented by Formulae 1 and 2. When the content of the binder resin is less than 5 parts by weight based on 100 parts by weight of the CGM, the CGM may be insufficiently dispersed and a homogeneous charge generating layer may not be obtained. In addition, the adhesive force with the electrically conductive substrate may be reduced. When the content of the binder resin is more than 350 parts by weight based on 100 parts by weight of the CGM, it is difficult to maintain a charged potential, and a desirable image cannot be obtained due to an insufficient sensitivity caused by excess binder resin.

The solvent used to prepare the coating dispersion to form a charge generating layer may differ according to the type of a binder resin employed. Accordingly, selecting a solvent, for example, which does not affect an adjacent layer when the charge generating layer is coated on the electrically conductive substrate. Particular examples of the solvents include methyl isopropyl ketone, methyl isobutyl ketone, 4-methoxy-4-methyl-2-pentanone, isopropyl acetate, t-butyl acetate, isopropyl alcohol, isobutyl alcohol, acetone, methylethyl ketone, cyclohexanone, 1,2-dichloroethane, 1,1,2-trichloroethane, 1,1,1-trichloroethane, trichloroethylene, tetrachloroethane, dichloromethane, tetrahydrofuran(THF), dioxane, dioxolane, methanol, ethanol, 1-propanol, 1-butanol, 2-butanol, 1-methoxy-2-propanol, ethyl acetate, butyl acetate, dimethyl sulfoxide, methylcellosolve, butyl amine, diethyl amine, ethylene diamine, isopropanol amine, triethanol amine, triethylene diamine, N,N′-dimethyl formamide, 1,2-dimethoxyethane, benzene, toluene, xylene, methylbenzene, ethylbenzene, cyclohexane, anisole, and the like. The respective solvents may be used alone or in combinations of two or more solvents.

A method of preparing a coating dispersion to form the charge generating layer will now be described in detail.

100 parts by weight of a CGM including the mixture of the compounds represented by Formulae 1 and 2, specifically, the mixed crystal of the compounds represented by Formulae 1 and 2, and 5˜350 parts by weight, specifically, 10˜200 parts by weight of a binder resin are mixed with 100˜10,000 parts by weight, specifically, 500˜8,000 parts by weight of a solvent. Glass beads, steel beads, zirconia beads, alumina beads, zirconia balls, alumina balls or steel balls and the like are added to the resultant mixture, and the mixture is dispersed for 2˜50 hours. The dispersing apparatus used herein may be, for example, an attritor, a ball-mill, a sand-mill, a banburry mixer, a roll-mill, a three-roll mill, a nanomiser, a microfluidizer, a stamp mill, a planetary mill, a vibration mill, a kneader, a homonizer, a Dyno-Mill, a micronizer, a paint shaker, a high-speed agitator, an ultimiser, an ultrasonic homogenizer, or the like. The respective dispersing apparatuses may be used alone or in combinations of two or more of them.

The obtained coating dispersion to form a charge generating layer is coated on the above-described electrically conductive substrate using a coating method such as a dip coating method, a ring coating method, a roll coating method, a spray coating method, or the like. The coated electrically conductive substrate is dried at 90 to 200° C. for 0.1 to 2 hours, thereby forming the charge generating layer.

Then, a charge transporting layer including a CTM and a binder resin may be formed on the charge generating layer. Reversely, the charge generating layer can be formed on a charge transporting layer including a CTM.

The CTM can be either a hole transporting material (HTM) that transports holes or an ETM which transports electrons. When the laminated type photosensitive layer is used as a negatively charged type, the HTM as the CTM is used as a main component. When the laminated type photosensitive layer is used as a positively charged type, the ETM is used as a main component. When both positive and negative-charged properties are required, the HTM can be used together with the ETM.

Specific examples of the HTM that may be included in the charge transporting layer include nitrogen containing cyclic compounds or condensed polycyclic compounds such as a hydrazone-based compound, a butadiene-based amine compound, a benzidine-based compound including N,N′-bis-(3-methylphenyl)-N,N′-bis(phenyl)benzidine, N,N,N′,N′-tetrakis(3-methylphenyl)benzidine, N,N,N′,N′-tetrakis(4-methylphenyl)benzidine, N,N′-di(naphthalene-1-yl)-N,N′-di(4-methylphenyl)benzidine, and N,N′-di(naphthalene-2-yl)-N,N′-di(3-methylphenyl)benzidine, a pyrene-based compound, a carbazole-based compound, an arylmethane-based compound, a thiazol-based compound, a styryl-based compound, a pyrazoline-based compound, an arylamine-based compound, an oxazole-based compound, an oxadiazole-based compound, a pyrazolone-based compound, a stilbene-based compound, a polyaryl alkane-based compound, a polyvinylcarbazole-based compound, a N-acrylamide methylcarbazole copolymer, a triphenylmethane copolymer, a styrene copolymer, polyacenaphthene, polyindene, a copolymer of acenaphthylene and styrene, and a formaldehyde-based condensed resin. Also, a high molecular weight compound having substituents of the above compounds in a main chain or a side chain may be used. The HTM may be used alone or in combinations of two or more of the compounds listed above.

Specific examples of the ETM that can be included in the charge transporting layer include electron-accepting low molecular compounds such as a benzoquinone-based compound, a naphthoquinone-based compound, an anthraquinone-based compound, a malononitrile-based compound, a diphenoquinone-based compound including the diphenoquinone-based compound having dioxazolene group according to the Formula 1, a fluorenone-based compound, a cyanoethylene-based compound, a cyanoquinodimethane-based compound, a xanthone-based compound, a phenanthraquinone-based compound, an anhydrous phthalic acid-based compound, a thiopyran-based compound, a dicyanofluorenone-based compound, a naphthalene tetracarboxylic acid diimide-based compound, a benzoquinoneimine-based compound, a diphenoquinone-based compound, a stilbenequinone-based compound, a diiminoquinone-based compound, a dioxotetracenedione compound and a pyran sulfide-based compound. Moreover, the ETM may include electron transporting polymers or n-type semiconducting pigments.

However, a CTM used in the present embodiment is not limited to the HTMs or ETMs described above. For example, any compound that has a charge mobility greater than 10⁻⁸ cm²/V·sec may be used as a CTM. The CTMs described above may be used in combinations of two or more compounds.

If the CTM has a film-forming characteristic, the charge transporting layer may be formed without a binder resin, but usually low molecular materials do not have any film-forming characteristic. Therefore, the CTM is dissolved or dispersed with a binder resin in a solvent to prepare a coating composition (solution or dispersion) to form a charge transporting layer, and then the solution or the dispersion is coated on the charge generating layer and dried to form the charge transporting layer. Examples of the binder resin used for the formation of the charge transport layer of the electrophotographic photoreceptor according to the present embodiment include, but are not limited to, an insulation resin which can form a film, such as polyvinyl butyral, polyarylates (condensed polymer of bisphenol A and phthalic acid, and so on), polycarbonate, a polyester resin, a phenoxy resin, polyvinyl acetate, acrylic resin, a polyacrylamide resin, a polyamide, polyvinyl pyridine, a cellulose-based resin, a urethane resin, an epoxy resin, a silicone resin, polystyrene, a polyketone, polyvinyl chloride, vinyl chloride-vinyliacetate copolymer, polyvinyl acetal, polyacrylonitrile, a phenolic resin, a melamine resin, casein, polyvinyl alcohol, and polyvinyl pyrrolidone; and an organic photoconductive polymer, such as poly N-vinyl carbazole, polyvinyl anthracene, polyvinyl pyrene, and so on. In an embodiment of the present general inventive concept, a polycarbonate resin is a preferable binder resin to be used to form a charge transporting layer. In particular, polycarbonate-Z derived from cyclohexylidene bisphenol is to polycarbonate-A derived from bisphenol A or polycarbonate-C derived from methylbisphenol-A, because polycarbonate-Z has a high abrasion resistance.

A content ratio of the CTM and the binder resin within the charge transporting layer may be in a range of 5 to 200 parts by weight, specifically in a range of 10 to 150 parts by weight of the CTM, based on 100 parts by weight of the binder resin. When the content of the CTM is less than 5 parts by weight based on 100 parts by weight of the binder resin, the charge transporting ability is insufficient and thus producing an electrophotographic photoreceptor having a reduced sensitivity and a high residual potential. Alternatively, when the content of the CTM exceeds 200 parts by weight based on 100 parts by weight of the binder resin, the relative binder resin content becomes too low such that a mechanical strength may be decreased.

The solvent used to prepare the coating composition to form the charge transporting layer of the electrophotographic photoreceptor according to the present may be varied according to the type of the binder resin, and may be selected in such a way that the solvent does not affect the charge generating layer formed underneath. Specifically, the solvent may be, for example, aromatic hydrocarbons such as benzene, xylene, ligroin, monochlorobenzene, and dichlorobenzene; ketones such as acetone, methyl ethyl ketone, and cyclohexanone; alcohols such as methanol, ethanol, and isopropanol; esters such as ethyl acetate and methyl cellosolve; halogenated aliphatic hydrocarbons such as carbon tetrachloride, chloroform, dichloromethane, dichloroethane, and trichloroethylene; ethers such as tetrahydrofuran(THF), dioxane, dioxolan, ethylene glycol, and monomethyl ether; amides such as N,N-dimethyl formamide, N,N-dimethyl acetamide; and sulfoxides such as dimethyl sulfoxide. The respective solvents may be used alone or in combination of two or more.

Next, a method of preparing the charge transporting layer will now be described in detail.

100 parts by weight of a binder resin and 5˜200 parts by weight of a CTM are mixed with a predetermined content of a solvent. In this regard, the content of the solvent may be in a range of 100 to 1,500 parts by weight, specifically in a range of 300 to 1,200 parts by weight of a solvent.

The obtained composition to form a charge transporting layer is coated on the charge generating layer. The coating process can be performed by a dipping coating, a ring coating, a roll coating, or a spray coating, or the like. The resultant substrate on which the charge transporting layer is coated is dried in a temperature range of 90 to 200° C. for 0.1˜2 hours, thereby forming the charge transporting layer.

A thickness of the charge transporting layer may be 2 to 100 μm, such as 5 to 50 μm, including 10 to 40 μm. When the thickness of the charge transporting layer is less than 2 μm, the charge transporting layer is too thin, and thus is not sufficiently durable and charging properties become poor. When the thickness of the charge transporting layer exceeds 100 μm, the physical abrasion resistance may increase but the response time and the printing image quality tend to be deteriorated. The combined thickness of the charge generating layer and the charge transporting layer may be conventionally selected from the range of 5 to 50 μm.

The charge transporting layer may further include an appropriate amount of a phosphate-based compound, a phosphine oxide-based compound, a silicone oil, or the like in order to enhance the abrasion resistance and provide lubricating characteristics to the surface of the charge transporting layer. In this regard, the content of each of the phosphate-based compound, the phosphinoxide-based compound, and the silicone oil may be in a range of 0.01 to 5 parts by weight.

Hereinafter, a single-layered type electrophotographic photoreceptor including a CGM including the mixture of the compounds represented by Formulae 1 and 2, specifically, the mixed crystal of the compounds represented by Formulae 1 and 2 in a single-layered type photosensitive layer, that is, a charge generating and transporting layer, according to another embodiment of the present general inventive concept will be described in detail.

A CGM including a mixture of the compounds represented by Formulae 1 and 2, specifically, a mixed crystal of the compounds represented by Formulae 1 and 2, a CTM, usually an HTM, and a binder resin are dispersed in a solvent to prepare a coating dispersion to form a single-layered type photosensitive layer. The obtained coating dispersion is coated on an electrically conductive substrate and then dried to obtain a single-layered type photosensitive layer. The thickness of the single-layered type photosensitive layer may be in a range of about 5 μm to about 50 μm, such as in a range of 10˜40 μm, including in a range of 15˜30 μm. When the thickness of the single-layered type photosensitive layer is less than 5 μm, sensitivity and mechanical durability may be insufficient. Alternatively, when the thickness of the single-layered type photosensitive layer exceeds 50 μm, the single-layered type photosensitive layer may be too thick, thereby deteriorating the electrical properties.

In the single-layered type photosensitive layer, the content of the CGM including a mixture of the compounds represented by Formulae 1 and 2, specifically, a mixed crystal of the compounds represented by Formulae 1 and 2 may be in a range of 0.1 to 200 parts by weight, and the content of the HTM may be in a range of 20 to 400 parts by weight, based on 100 parts by weight of the binder resin. The CTM, for example, may include both a HTM and an ETM. This is because, in a single-layered type photosensitive layer in which a CTM is dispersed together with a CGM and a binder resin and thus, charge generation tends to occur near the surface of the photosensitive layer. Thus, both holes and electrons may be transported in the photosensitive layer. As a result, the single-layered type photosensitive layer may further include 5-100 parts by weight of an ETM based on 100 parts by weight of the binder resin. The ratio of the HTM to the ETM may be appropriately determined in consideration of a polarity and a mobility of charges.

Examples of the CTM that may be included in the single-layered type photosensitive layer are the same as described above. The binder resin may be a polymer to form an electrically insulative film. Examples of such polymer may be the same as described above. The binder resins may be used alone or in combinations of two or more.

Next, a method of preparing a coating dispersion to form a single-layered type photosensitive layer will now be described in detail.

Based on 100 parts by weight of a binder resin, 0.1˜200 parts by weight of a CGM including a mixture of the compounds represented by Formulae 1 and 2, specifically, a mixed crystal of the compounds represented by Formulae 1 and 2, and 20˜400 parts by weight of a HTM are mixed with a predetermined content of a solvent. In this regard, a content of the solvent used may be in a range of 50 to 1,000 parts by weight based on 100 parts by weight of the binder resin. The obtained coating dispersion may further include 5˜100 parts by weight of an ETM based on 100 parts by weight of the binder resin. Glass beads, steel beads, zirconia beads, alumina beads, zirconia balls, alumina balls, steel balls and the like are added to the mixture, and the mixture is then dispersed for 2˜50 hours. Here, the mixture may be dispersed by mechanical grinding or milling. Examples of a dispersing device are the same as described above.

The obtained coating dispersion to form a single-layered type photosensitive layer is coated on the electrically conductive substrate. The coating method may be a dipping coating method, a ring coating method, a roll coating method, or a spray coating method and the like. The obtained coated substrate is dried in a temperature range of 90 to 200° C. for 0.1 to 2 hours, thereby forming the single-layered type photosensitive layer. Examples of the solvent used to prepare the coating dispersion to form a single-layered type photosensitive layer may be the same as described above.

An electrophotographic photoreceptor according to the present embodiment may further include, along with the binder resin, additives such as a plasticizer, a surface modifier, a dispersion stabilizer, and an antioxidant, regardless of whether the electrophotographic photoreceptor is a laminated type or a single-layered type photoreceptor.

The plasticizer may include, for example, biphenyl, biphenyl chloride, terphenyl, dibutyl phthalate, diethylene glycol phthalate, dioctyl phthalate, triphenyl phosphoric acid, methyl naphthalene, benzophenone, a chlorinated paraffin, polypropylene, polystyrene, and various fluorinated hydrocarbons, but is not limited thereto. The surface modifier that may be used in the present embodiment may include, for example, a silicone oil, and a fluorine resin, but is not limited thereto. The antioxidant is included in order to improve resistance to environment and stability against harmful light and heat. Specific examples of the antioxidant used in the present embodiment include a chormanol derivative such as tocopherol, or an etherified or esterified compounds thereof, a polyaryl alkane compound, a hydroquinone derivative and a mono- or dietherified compound thereof, a benzophenone derivative, a benzotriazole derivative, a phenylene diamine derivative, a phosphonic acid ester, a hypophosphoric acid ester, a phenolic compound, a sterically-hindered phenolic compound, a straight-chain amine compound, a cyclic amine compound, and a sterically-hindered amine compound, but is not limited thereto.

An electrophotographic photoreceptor according to the present embodiment may further include, an undercoat layer may be further formed between the electrically conductive substrate and the photosensitive layer in order to prevent charge injection to the photosensitive layer from the electrically conductive substrate and/or improve adhesion therebetween, regardless of whether the electrophotographic photoreceptor is a laminated type or a single-layered type photoreceptor.

The undercoat layer may be formed by dispersing a conductive powder such as carbon black, graphite, metal powder, or a metal oxide powder such as indium oxide, tin oxide, indium tin oxide, or titanium oxide in a binder resin such as polyamide, polyvinylalcohol, casein, ethylcellulose, gelatin, a phenol resin, or the like. The undercoat layer in this form, for example, may have a thickness of about 5 μm to about 50 μm. The undercoat layer may be also formed of an inorganic layer, for example, anodic aluminium oxide, aluminium oxide, and aluminium hydroxide. The inorganic layer, such as the anodic aluminium oxide, for example, has a thickness in the range of approximately 0.05 μm to approximately 5 μm. These two types of undercoat layers may be formed together.

The electrophotographic photoreceptor of the present embodiment may further include, if necessary, a surface protecting layer on the photosensitive layer.

Hereinafter, an electrophotographic imaging apparatus employing the single-layered type or the laminated type electrophotographic photoreceptor according to the present embodiment described above will be described.

The electrophotographic photoreceptor according to the present embodiment may be incorporated into electrophotographic imaging apparatuses such as laser printers, copying machines, facsimile machines, LED printers, and the like.

FIG. 1 is a schematic view illustrating the electrophotographic imaging apparatus according to an embodiment of the present general inventive concept.

Referring to FIG. 1, the electrophotographic imaging apparatus according to the current embodiment includes a semiconductor laser 1. Laser light that is signal-modulated by a control circuit 11 according to an image information, is collimated by an optical correction system 2 after being radiated and performs scanning while being reflected by a polygonal rotatory mirror 3. The laser light is focused on a surface of an electrophotographic photoreceptor 5 by a f-θ lens 4 and exposes the surface according to the image information. Since the electrophotographic photoreceptor 5 may be already charged by a charging apparatus 6, an electrostatic latent image is formed by the exposure, and then becomes visible by a developing apparatus 7. The visible image is transferred to an image receptor 12, such as paper, by a transferring apparatus 8, and is fixed in a fixing apparatus 10 and provided as a print result. The electrophotographic photoreceptor 5 can be used repeatedly by removing a coloring agent that remains on the surface thereof by a cleaning apparatus 9. The electrophotographic photoreceptor 5 here is illustrated in a form of a drum, however, as described above, the present general inventive concept is not limited thereto, and the electrophotographic photoreceptor 5 may also be in a form of a sheet, a belt, or the like. The electrophotographic photoreceptor 5 according to the present embodiment may be installed in the electrophotographic imaging apparatus or may also be detached from the electrophotographic imaging apparatus.

Hereinafter, the present general inventive concept will be described in further detail with reference to the following examples. These examples are, however, provided for exemplary purposes and should not be construed to limit scope of the present general inventive concept.

### EXAMPLE 1

A mixture including 0.25 parts by weight of bisphthalocyanine compound represented by Formula 1 where each of R1-R14 is a hydrogen atom, a central metal element of Pc1 and Pc2, M₁ and M₂, is TiO, and n=1, 4.75 parts by weight of γ-type oxotitanyl phthalocyanine, 2.5 parts by weight of polyvinylbutyral resin (BM2, produced by Sekisui Chemical Co.), and 80 parts by weight of tetrahydrofurane (THF) was dispersed with glass beads having a diameter of 1 to 1.5 mm for 30 minutes, using a paint shaker. The obtained mixture was ball-milled for 30 minutes. The two operations were repeated four times. 272 parts by weight of THF was added to the resultant product to obtain a coating dispersion to form a charge generating layer.

The coating dispersion was uniformly coated on an aluminum drum with an anodized aluminium (alumite) surface layer with a diameter of 24 mmΦ, a length of 236 mm and a thickness of 1 mm and dried at 150° C. for 1 hour, thereby obtaining a charge generating layer having a thickness of 0.1˜0.5 μm.

4.2 parts by weight of 4-dibenzylamino-2-methylbenzaldehyde diphenylhydrazone (CTC191, produced by ANAN Corp.), 4.2 parts by weight of 1,1-bis-(p-diethylaminophenyl)-4,4-diphenyl-1,3-butadiene (T405, produced by ANAN Corp.), 10.5 parts by weight of polycarbonate resin (B500, produced by Idemitsu Kosan), and 1 part by weight of an antioxidant (Irganox 565: produced by Ciba Specialty Chemicals Inc.) were dissolved in a mixed solvent of 70 parts by weight of THF and 8.6 parts by weight of xylene to prepare a coating solution to form a charge transporting layer. The coating solution was coated on the charge generating layer and dried at 150° C. for 1 hour to form a charge transporting layer having a thickness of 20 μm, thereby completing a manufacture of a negatively-charged type laminated type photoreceptor.

### EXAMPLE 2

4,000 parts by weight of alumina balls having an average diameter of 5 mm, 160 parts by weight of titanium oxide particles (produced by Ishihara Inc., TTO-55N, about 35 nm of an average primary diameter), and 4 parts by weight of 2,6-di-tert-butyl-4-methylphenol (produced by Aldrich Co.) as an antioxidant were added to a solution prepared by dissolving 80 parts by weight of a nylon resin (CM8000, produced by Toray Industries Inc. ) in 320 parts by weight of an organic mixed solvent of methanol/propanol in a weight ratio of 1:1, and then dispersed by ball-milling for 20 hours. The obtained dispersion was diluted with 1,120 parts by weight of the organic mixed solvent to prepare a coating composition to form an undercoat layer.

The coating solution to form an undercoat layer was coated to a thickness of 1˜5 μm on drum with a diameter of 24 mmΦ, a length of 236 mm and a thickness of 1 mm and then dried in an oven at 60□ for 30 minutes to form an undercoat layer.

The charge generating layer and the charge transporting layer were sequentially formed on the undercoat layer in the same manner as in Example 1 to prepare a negatively-charged type laminated type photoreceptor.

### EXAMPLE 3

A negatively-charged type laminated type photoreceptor was prepared in the same manner as in Example 1, except that a coating dispersion to form a charge generating layer was prepared using 4.75 parts by weight of α-type oxotitanyl phthalocyanine prepared using the method disclosed in U.S. Pat. No. 4,728,592, 0.25 parts by weight of the bisphthalocyanine compound used in Example 1, and 2.5 parts by weight of polyvinylbutyral resin (BM2, produced by Sekisui Chemical Co.). In the present experiment, a content of THF used was the same as in Example 1.

### EXAMPLE 4

4,000 parts by weight of alumina balls having an average diameter of 5 mm, 160 parts by weight of titanium oxide particles (produced by Ishihara Inc., TTO-55N, about 35 nm of an average primary diameter), and 4 parts by weight of 2,6-di-tert-butyl-4-methylphenol (produced by Aldrich Co.) as an antioxidant were added to a solution prepared by dissolving 80 parts by weight of a nylon resin (CM8000, produced by Toray Industries Inc. ) in 320 parts by weight of an organic mixed solvent of methanol/propanol in a weight ratio of 1:1, and then dispersed by ball-milling for 20 hours. The obtained dispersion was diluted with 1,120 parts by weight of the organic mixed solvent to prepare a coating composition to form an undercoat layer.

The coating solution to form an undercoat layer was coated to a thickness of 1˜5 μm on an an aluminum drum with a diameter of 24 mmΦ, a length of 236 mm and a thickness of 1 mm and then dried in an oven at 60° C. for 30 minutes to form an undercoat layer.

The charge generating layer and the charge transporting layer were sequentially formed on the undercoat layer in the same manner as in Example 3 to prepare a negatively-charged type laminated type photoreceptor.

### EXAMPLE 5

A mixture including including 0.05 parts by weight of bisphthalocyanine compound represented by Formula 1 where each of R1-R14 is a hydrogen atom, a central metal element of Pc1 and Pc2, M₁ and M₂, is TiO, and n=1, 0.95 parts by weight of α-type oxotitanyl phthalocyanine, 37 parts by weight of tetra-N,N,N′,N′-toluyl-benzidine, 12 parts by weight of 3,5-dimethyl-3′,5′-di-tert-butyl-4,4′-diphenoquinone, 50 parts by weight of a polycarbonate resin (B500, Idemitsu Kosan), and 700 parts by weight of THF was ball-milled with zirconium oxide beads having a diameter of 3 mm for 72 hours to prepare a coating dispersion to form a single-layered type photosensitive layer.

The coating dispersion to form a single-layered type photosensitive layer was uniformly coated on an an aluminum drum with an anodized aluminium (alumite) surface layer with a diameter of 24 mmΦ, a length of 236 mm and a thickness of 1 mm and then dried at 150° C. for 1 hour to form a single-layered type photosensitive layer having a thickness of 20 μm, thereby completing a positively-charged single-layered type photoreceptor.

### EXAMPLE 6

A negatively-charged laminated type photoreceptor was prepared in the same manner as in Example 1, except that the coating dispersion to form a charge generating layer prepared according to Example 1 was used after having been left to stand in an oven at 30° C. for one month.

### EXAMPLE 7

A negatively-charged laminated type photoreceptor was prepared in the same manner as in Example 3, except that the coating dispersion to form a charge generating layer prepared according to Example 3 was used after having been left to stand in an oven at 30° C. for one month.

### COMPARATIVE EXAMPLE 1

A negatively-charged laminated type photoreceptor was prepared in the same manner as in Example 1, except that only 5.0 parts by weight of γ-type oxotitanyl phthalocyanine was used as a CGM.

### COMPARATIVE EXAMPLE 2

A negatively-charged laminated type photoreceptor was prepared in the same manner as in Example 3, except that only 5.0 parts by weight of α-type oxotitanyl phthalocyanine was used as a CGM.

### COMPARATIVE EXAMPLE 3

A positively-charged single-layered type photoreceptor was prepared in the same manner as in Example 5, except that only 1 part by weight of α-type oxotitanyl phthalocyanine was used as a CGM.

Evaluation of Electrical Properties

Electrophotographic properties of the electrophotographic photoreceptors prepared in the Examples 1-7 and Comparative Examples 1-3 were evaluated using a drum type photoreceptor evaluating apparatus (produced by QEA Co., “PDT-2000”) under environmental conditions of a temperature of 23° C. and a relative humidity of 50%. The results are illustrated in Table 1.

The laminated type photoreceptors were charged to a surface potential (V₀) of −800 V by adjusting a corona discharge voltage while rotating the electrophotographic photoreceptors at a speed of 50 rpm. The single-layered type photoreceptors prepared according to Example 5 and Comparative Example 3 were charged to a surface potential (V₀) of 700V. Each of the electrophotographic photoreceptors was then exposed to monochromatic light having a wavelength of 780 nm, which was emitted from an exposure unit, while varying an amount of the exposure energy. Then, the relationship between exposure energies and surface potentials for each of the electrophotographic photoreceptor drums was measured. From this, E_{1/2} (μJ/cm2) which denotes the exposure energy per unit area that is required to decrease the surface potential of an electrophotographic photoreceptor drum to half of the initial surface potential thereof, −400 V in the case of the laminated type photoreceptors or 350V in the case of the single-layered type photoreceptors of Example 5 and Comparative Example 3, were determined. E₁₀₀ (μJ/cm2) which denotes an exposure energy per unit area that is required to decrease the surface potential of an electrophotographic photoreceptor drum to −100 V in the case of the laminated type photoreceptors, or to 100 V in the case of the single-layered type photoreceptors of Example 5 and Comparative Example 3 were also obtained. E_{1/2} and E₁₀₀ are each a measure of sensitivity for any electrophotographic photoreceptor drum. In addition, residual voltages Vᵣ (V) of the laminated type photoreceptors and the single-layered type photoreceptors were measured after 10 seconds was passed from the start of the irradiation of monochromatic light having a wavelength of 780 nm.

TABLE 1

| | | Undercoat | | | |
|---|---|---|---|---|---|
| | Type of photoreceptor/CGM | layer | Vᵣ (V) | E_{1/2} (μJ/cm²) | E₁₀₀ (μJ/cm²) |
| Ex 1* | Laminated type/0.25 parts of | Alumite layer | 7 | 0.13 | 0.52 |
| | bisphthalocyanine compound + | | | | |
| | 4.75 parts of γ-type oxotitanyl | | | | |
| | phthalocyanine | | | | |
| Ex 2 | Laminated type/0.25 parts of | Titanium oxide | 9 | 0.13 | 0.55 |
| | bisphthalocyanine compound + | particles | | | |
| | 4.75 parts of γ-type | dispersed in a | | | |
| | oxotitanyl phthalocyanine | nylon resin | | | |
| Ex 3 | Laminated type/0.25 parts of | Alumite layer | 8 | 0.30 | 0.71 |
| | bisphthalocyanine compound + | | | | |
| | 4.75 parts of α-type | | | | |
| | oxotitanyl phthalocyanine | | | | |
| Ex 4 | Laminated type/0.25 parts of | Titanium oxide | 12 | 0.29 | 0.74 |
| | bisphthalocyanine compound + | particles | | | |
| | 4.75 parts of α-type | dispersed in a | | | |
| | oxotitanyl phthalocyanine | nylon resin | | | |
| Ex 5 | Single-layered type/0.05 parts | Alumite layer | 20 | 0.27 | 0.80 |
| | of bisphthalocyanine | | | | |
| | compound + 0.95 parts of α- | | | | |
| | type oxotitanyl phthalocyanine | | | | |
| Ex 6 | Laminated type/The coating | Alumite layer | 12 | 0.16 | 0.65 |
| | dispersion to form a charge | | | | |
| | generating layer prepared | | | | |
| | according to Example 1 was | | | | |
| | used after having been left to | | | | |
| | stand for one month | | | | |
| Ex 7 | Single-layered type/The | Alumite layer | 14 | 0.32 | 0.82 |
| | coating dispersion to form a | | | | |
| | charge generating layer | | | | |
| | prepared according to | | | | |
| | Example 5 was used after | | | | |
| | having been left to stand for | | | | |
| | one month | | | | |
| CE 1^{#} | Laminated type/5.0 parts of | Alumite layer | 8 | 0.15 | 0.67 |
| | γ-type oxotitanyl | | | | |
| | phthalocyanine | | | | |
| CE 2 | Laminated type/5.0 parts of | Alumite layer | 10 | 0.30 | 0.75 |
| | α-type oxotitanyl | | | | |
| | phthalocyanine | | | | |
| CE 3 | Single-layered type/1.0 parts | Alumite layer | 27 | 0.31 | 1.12 |
| | of α-type oxotitanyl | | | | |
| | phthalocyanine | | | | |

*Ex: Example,
^{#}CE: Comparative Example

Referring to Table 1, the electrophotographic photoreceptors prepared according to Examples 1, 3, and 5 including the bisphthalocyanine compound represented by Formula 1 and the phthalocyanine compound represented by Formula 2 as a CGM have smaller Vᵣ, E_{1/2} and E₁₀₀ values than values of the electrophotographic photoreceptors prepared according to Comparative Examples 1, 2 and 3 including only α-type or γ-type oxotitanyl phthalocyanine as a CGM. That is, when the bisphthalocyanine compound represented by Formula 1 and the phthalocyanine compound represented by Formula 2 were used as a CGM, a lower residual voltage and a higher sensitivity were obtained than when only the phthalocyanine compound represented by Formula 2 was used as a CGM.

Meanwhile, when a coating dispersion to form a charge generating layer was used immediately after the coating dispersion preparation (Example 1) and when a coating dispersion to form a charge generating layer was used after having been left to stand for one month from its preparation (Example 6), Vᵣ, E_{1/2} and E₁₀₀ values were similar to each other. Therefore, it can be seen that the mixed crystal of the bisphthalocyanine compound represented by Formula 1 and the phthalocyanine compound represented by Formula 2 according to the present general inventive concept have stable electrical properties. The same results can be seen by comparing Vᵣ, E_{1/2} and E₁₀₀ values of Examples 3 and 7.

A mixture of a bisphthalocyanine compound represented by Formula 1 and a phthalocyanine compound represented by Formula 2 used as a CGM in an electrophotographic photoreceptor according to an embodiment of the present general inventive concept is more stable with respect to a transition of crystal type, crystal growth, and/or agglomeration in a coating dispersion to form a photosensitive layer than a conventional phthalocyanine-based charge generating material. Therefore, an electrophotographic photoreceptor including the mixture as a CGM has excellent, stable electrical properties. Thus, an electrophotographic imaging apparatus including the electrophotographic photoreceptor can provide high quality images. In addition, the electrophotographic photoreceptor can be prepared with a relatively low manufacturing costs.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. An electrophotographic photoreceptor, comprising:
an electrically conductive substrate; and a photosensitive layer formed on the electrically conductive substrate,
wherein the photosensitive layer comprises a mixture of a bisphthalocyanine compound represented by Formula 1 and a phthalocyanine compound represented by Formula 2:
Pc1-X-Pc2 [Formula 1]
where Pc1 is represented by: 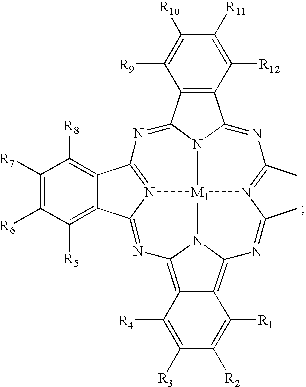
Pc2 is represented by: 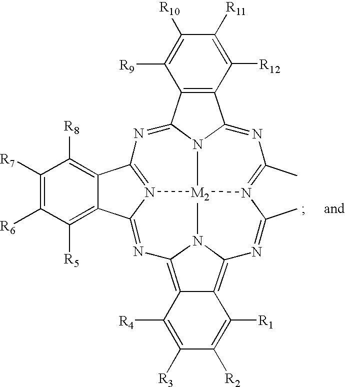
X is a quadrivalent connecting group represented by: 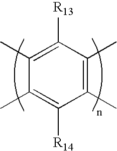
where R₁-R₁₄ are each independently a hydrogen atom, a halogen atom, a nitro group, an alkyl group, or an alkoxy group;
M₁ and M₂, which may be the same or different from each other, are each a hydrogen atom, Cu, Fe, Mg, Sn, Pb, Zn, Co, Ni, Mo, or halogenated aluminum, or Ti, V, Zr, Ge, Ga, Sn, Si or In with an oxygen atom, a halogen atom, or a hydroy group bonded thereto; and
n is an integer ranging from 1 to 3; and 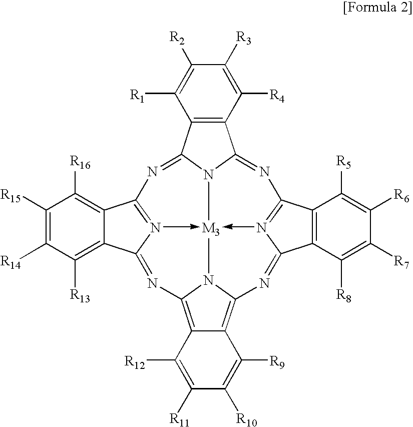
where M₃ is a hydrogen atom, Cu, Fe, Mg, Sn, Pb, Zn, Co, Ni, Mo, halogenated aluminum, or Ti, V, Zr, Ge, Ga, Sn, Si or In with an oxygen atom, a halogen atom, or a hydroxy group bonded thereto; and R₁-R₁₆ are each independently a hydrogen atom, a halogen atom, a nitro group, an alkyl group or an alkoxy group.

2. The electrophotographic photoreceptor of claim 1, wherein the photosensitive layer comprises:
a single-layered type photosensitive layer having a charge generating capability and a charge transporting capability.

3. The electrophotographic photoreceptor of claim 1, wherein the photosensitive layer comprises:
a laminated type photosensitive layer including a charge generating layer and a charge transporting layer, separately.

4. The electrophotographic photoreceptor of claim 1, wherein a weight ratio of the bisphthalocyanine compound represented by Formula 1 to the phthalocyanine represented by Formula 2 is in a range of 0.01:1 to 1:1.

5. The electrophotographic photoreceptor of claim 1, wherein the mixture of the bisphthalocyanine compound represented by Formula 1 and the phthalocyanine compound represented by Formula 2 is a mixed crystal.

6. The electrophotographic photoreceptor of claim 1, further comprising:
an undercoat layer interposed between the electrically conductive substrate and the photosensitive layer.

7. An electrophotographic imaging apparatus, comprising:
an electrophotographic photoreceptor, wherein
the electrophotographic photoreceptor comprises: an electrically conductive substrate; and a photosensitive layer formed on the electrically conductive substrate, wherein
the photosensitive layer comprises a mixture of a bisphthalocyanine compound represented by Formula 1 and a phthalocyanine compound represented by Formula 2:
Pc1-X-Pc2 [Formula 1]
where Pc1 is represented by: 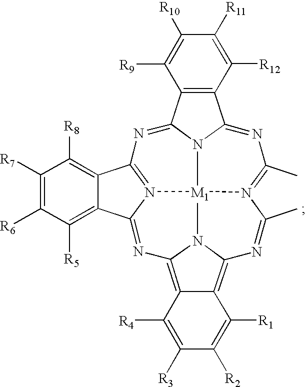
Pc2 is represented by: 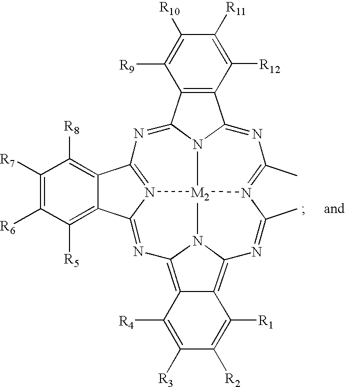
X is a quadrivalent connecting group represented by: 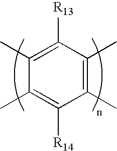
where R₁-R₁₄ are each independently a hydrogen atom, a halogen atom, a nitro group, an alkyl group, or an alkoxy group;
M₁ and M₂, which may be the same or different from each other, are each a hydrogen atom, Cu, Fe, Mg, Sn, Pb, Zn, Co, Ni, Mo, or halogenated aluminum, or Ti, V, Zr, Ge, Ga, Sn, Si or In with an oxygen atom, a halogen atom, or a hydroy group bonded thereto; and
n is an integer ranging from 1 to 3; and 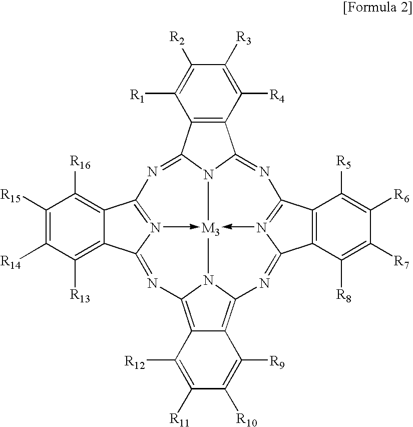
where M₃ is a hydrogen atom, Cu, Fe, Mg, Sn, Pb, Zn, Co, Ni, Mo, halogenated aluminum, or Ti, V, Zr, Ge, Ga, Sn, Si or In with an oxygen atom, a halogen atom, or a hydroxy group bonded thereto; and R₁-R₁₆ are each independently a hydrogen atom, a halogen atom, a nitro group, an alkyl group or an alkoxy group.

8. The electrophotographic imaging apparatus of claim 7, wherein the photosensitive layer comprises:
a single-layered type photosensitive layer having a charge generating capability and a charge transporting capability.

9. The electrophotographic imaging apparatus of claim 7, wherein the photosensitive layer comprises:
a laminated type photosensitive layer comprising a charge generating layer and a charge transporting layer, separately.

10. The electrophotographic imaging apparatus of claim 7, wherein a weight ratio of the bisphthalocyanine compound represented by Formula 1 to the phthalocyanine represented by Formula 2 is in a range of 0.01:1 to 1:1.

11. The electrophotographic imaging apparatus of claim 7, further comprising:
an undercoat layer interposed between the electrically conductive substrate and the photosensitive layer.

12. The electrophotographic imaging apparatus of claim 7, wherein the mixture of a bisphthalocyanine compound represented by Formula 1 and a phthalocyanine compound represented by Formula 2 is a mixed crystal.

13. An electrophotographic photoreceptor, comprising:
an electrically conductive substrate; and
a photosensitive layer formed on the electrically conductive substrate, the photosensitive layer including a mixture of a bisphthalocyanine compound and a phthalocyanine compound.
